(19) United States
(12) Patent Application Publication
(10) Pub. No.: US 2019/0226273 A1
(43) Pub. Date: Jul. 25, 2019

(54) ATTACHABLE WINDOW FOR WINDPROOF VINYL

(71) Applicant: Min Kim, Gunpo-si (KR)

(72) Inventor: Min Kim, Gunpo-si (KR)

(21) Appl. No.: 16/132,344

(22) Filed: Sep. 14, 2018

(30) Foreign Application Priority Data
Jan. 22, 2018 (KR) 10-2018-0007696

(51) Int. Cl. E06B 7/32; E06B 3/80; E06B 3/28

(52) U.S. Cl. CPC E06B 7/32; E06B 3/285; E06B 3/80

(57) ABSTRACT

Provided is an attachable window for a windproof vinyl including: a door frame attachable to a windproof vinyl, defining a first opening, and serving as a frame of the first opening, wherein the windproof vinyl is installed on a window frame; a door cap covering the first opening; and first and second detachable members provided on a front side of the door frame and a back side of the door cap, respectively, and detachably attaching the door cap to the door frame.

### CROSS REFERENCE

This application claims priority of Korean patent application number 10-2018-0007696 filed on Jan. 22, 2018. The disclosure thereof is incorporated herein by reference in its entirety.

### TECHNICAL BACKGROUND

The present invention relates to an attachable window for windproof vinyl, and more particularly, to an attachable window for windproof vinyl which can be attached to a windproof vinyl installed on a window frame. A user can opens and closes for a window ventilation through the attachable window.

In general, a thermal insulation is provided in walls of a building such as a single home or an apartment to block a cold air from outside. However, no thermal insulation is provided in verandas and windows to protects an interior from an outside cold air. Thus, in winter season or when an outside temperature is low, a heating efficiency is poor and it is not easy to keep the inside warm and block the cold air from outside.

Windproof vinyls or window insulation film (hereinafter, integrally referred to as “windproof vinyl” or “windproof vinyls”), windproof tapes and the like have been used to prevent the outside cold air. However, another problem is that windows can not be opened or closed once windproof vinyls, or windproof tapes are installed to the windows.

Especially, in North America and Europe, heat shrink windproof vinyls have been widely used for better heating efficiency due to its compatibility with window structures of general residential buildings and good transparency. However, opening the windows for ventilation is not allowed once the heat shrink windproof vinyls are installed since the heat shrink windproof vinyls are installed in such a manner of completely covering the entire windows,

### RELATED PRIOR ARTS

Korean Utility Patent Registration No. 20-0462254 (published on Sep. 3, 2012).

Korean Utility Patent Publication No. 20-2010-0011483 (published on Nov. 24, 2010).

### DETAILED DESCRIPTION OF THE INVENTION

### Problem to be Solved

The present invention may solve the above-mentioned issues.

According to an embodiment of the present invention, an attachable window for a windproof vinyl is provided. The windproof vinyl is attached on a window frame to keep the house warm. The attachable window is attached to the windproof vinyl and forms an opening in the windproof vinyl. The window can be opened through the opening in the windproof vinyl for ventilation and closed through the opening in the windproof vinyl for a better heating efficiency.

### SUMMARY OF INVENTION

According to an embodiment, an attachable window for a windproof vinyl includes: a door frame attachable to a windproof vinyl and having a first opening, wherein the windproof vinyl is installable on a window frame; a door cap covering the first opening; and first and second detachable members provided on a front side of the door frame and a back side of the door cap, respectively, and detachably attaching the door cap to the door frame.

The door frame is a first double-sided tape, or an adhesive.

The first and the second detachable members include first and second magnets, respectively. The first and the second magnets have opposite magnetic polarities to each other and are attachable to and detachable from each other by a magnetic force.

The first and the second detachable members include a metal piece and a magnet, respectively. Alternatively, the first and the second detachable members include a magnet and a metal piece, respectively.

The first and the second detachable members include hook and loop fastners, respectively. The hook and loop fastners are attachable to and detachable from each other.

The door cap is made of a transparent material. The second detachable member is fixed to a back side of the transparent film using a second double-sided tape or an adhesive.

The attachable window of claim 1 may further includes a first tab extending outward from an edge of the door cap.

The attachable window of claim 1 may further includes a second tab extending from an edge of the second detachable member. The first tab and the second tab are attached to each other. The door cap is a transparent film.

The attachable window of claim 1 may further includes a second tab extending outward from an edge of the second detachable member. The second tab further extends outside an edge of the door cap.

### Advantages of Invention

According to an embodiment of the present invention, an attachable window has a first opening, is attached to the windproof vinyl, and forms a second opening in the windproof vinyl. The windproof vinyl is attached on a window frame to keep the house warm. The window can be opened through the first and the second openings for ventilation. Thus, the conventional problem can be solved that no ventilation is allowed once heat shrink type of windproof vinyl is installed.

In addition, the opening can be closed at a user's disposal to reduce heat loss and to maintain a better heating efficiency.

### BRIEF DESCRIPTION OF DRAWINGS

FIG. 1 is a perspective view of an attachable window for a windproof vinyl according to an embodiment of the present invention;

FIG. 2 is a perspective view showing a door frame and a door cap of an attachable window for a windproof vinyl according to an embodiment of the present invention.

FIG. 3 is an exploded perspective view showing the door frame and the door cap of an attachable window for a windproof vinyl according to an embodiment of the present invention.

FIG. 4 shows an attachable window for a windproof vinyl according to another embodiment of the present invention, in which a door cap has a first tab.

FIG. 5 is shows an attachable window for a windproof vinyl according to yet another embodiment of the present invention, in which the attachable window has a second tab.

FIGS. 6 to 10 show how to install on a windproof vinyl an attachable window for windproof vinyl according to an embodiment of the present invention and how to ventilate using the attachable window.

### DETAILED DESCRIPTION OF THE INVENTION

Embodiments of the invention will be provided below in reference to the accompanying drawings. These embodiments are described in detail sufficient for a person having an ordinary skill in the art to understand. It should be understood that the various embodiments of the present invention are different, but need not be mutually exclusive. The features, structures, and characteristics described herein may be modified and implemented in other embodiments without departing from the spirit and scope of the present invention. The position or arrangement of the individual components shown in embodiments may be modified without departing from the spirit and scope of the present invention.

The following detailed description is, therefore should not be construed as limiting the scope of the present invention. Rather, the scope of invention is defined by the appended claims and the full scope of their equivalents. In the drawings, the same reference numerals refer to components having the same or similar functions.

Terms and terminologies used in the present invention should be construed to have general dictionary meanings in the related field in consideration of a person having an ordinary skill in the art, new technologies, court precedents, and the like. Some terms may have a unique meaning rather than having a general dictionary meaning. In that case, such terms will be defined specifically and in detail. Terms used in the present invention should be construed in view of entire specification and in a close relation with other terms and components disclosed in the entire specification, rather than being construed individually and independently.

Whenever an element is referred to as “including” an element, it is to be understood that the element may include other elements, without departing from the spirit or scope of the present invention. In addition, terms such as “member,” “module,” and the like indicates a unit component processing a given function or operation, which may be implemented in hardware or software, or a combination of hardware and software.

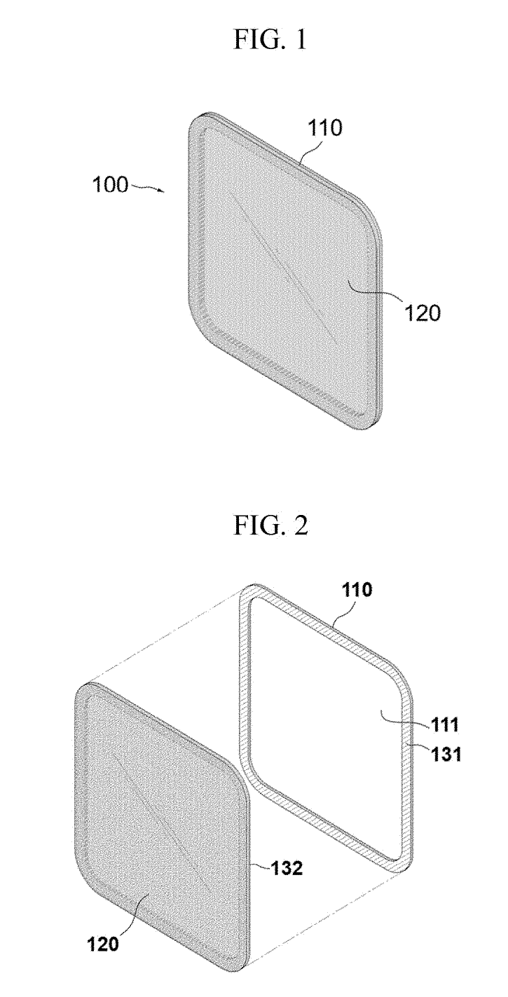

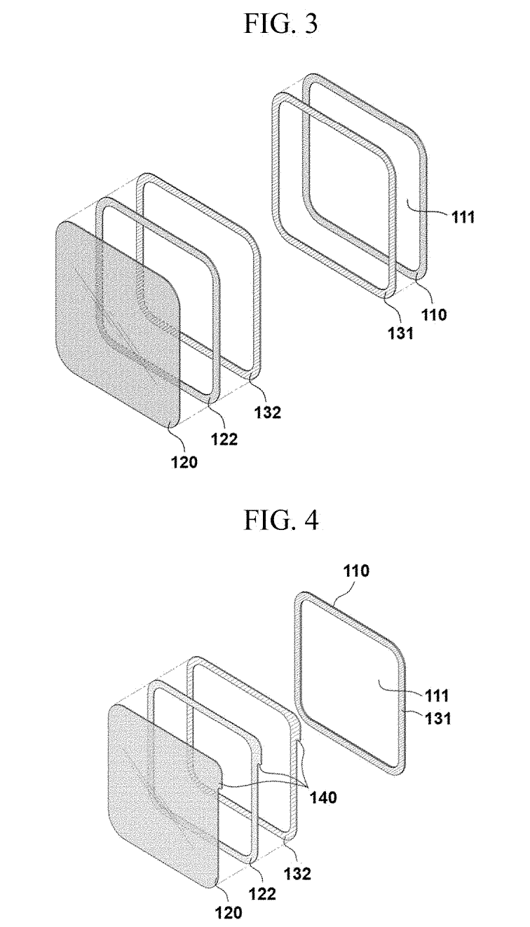

As shown in FIGS. 1 to 7, an attachable window for windproof vinyl (100) according to an embodiment of the present invention includes: a door frame (110) attachable to a windproof vinyl (10), wherein the windproof vinyl is installed on a window frame, wherein the door frame (110) having a first opening (111) and defines a second opening in the windproof vinyl; a door cap (120) covering the first opening; and first and second detachable member (131, 132) provided on a front side of the door frame (110) and a back side of the door cap (120), respectively, and detachably attaching the door cap (120) to the door frame (110).

First, as shown in FIGS. 1 to 3, the door frame (110) having a first opening (111) is attached to the windproof vinyl (10). The door frame (110) may be formed in various shapes such as a circle, a semi-circle, an ellipse, a triangle, a rectangle, and a polygon at a user's disposal. The door frame (110) may have a various size at a user's disposal, but it is preferred to be sufficiently big for a user's hand to pass therethrough.

The door frame (110) may be a thin frame made of a synthetic resin. In an embodiment, a glue may be applied to the backside of the door frame (110) so that the door frame (110) is securely attached to the windproof vinyl by the glue. In another embodiment, a double-sided tape itself may serve as the door frame (110). The double-sided tape is directly attached to the windproof vinyl without any frame to define define the first opening. In yet another embodiment, an adhesive or a glue applied to a back side of the first detachable member (131) may serve as the door frame (110).

The windproof vinyl enclosed by the door frame (110), which is hereinafter referred to as a to-be-opening area, is cut out to form a second opening. Specifically, when the double-sided tape itself serves as the door frame (110), sided tape may be attached to the windproof vinyl to define the to-be-opening area on the windproof vinyl. The double-sided tape with a good adhesion force may firmly hold the windproof vinyl while the to-be-opening area of the windproof vinyl is cut out. Thus, it is possible to prevent the windproof vinyl located outside the to-be-opening area from being tear off. In an embodiment, the detachable member may be fixed to the front side of the door frame (110) in advance before the door frame (110) is attached the windproof vinyl. Under this structure the double-sided tape is advantageous in that no additional door frame is necessary and the detachable member can be directly attached in advance, thereby reducing a manufacturing cost. In yet another embodiment, the first detachable member (131) may serve as the door frame (110) and an adhesive or a glue applied to the first detachable member (131) may serve as the door frame (110). For example, a velcro fastner (or a hook and loop fastner) having the first opening (111) is prepared as the first detachable member (131). An adhesive is applied to a back side of the velcro fastner. The back side of the velcro fastner is attached to the windproof vinyl to define the to-be-opening area on the windproof vinyl. The to-be-opening area is the area corresponding to the first opening (111). The to-be-opening area of the windproof vinyl is cut out to form the second opening in the windproof vinyl. In this example, the velcro fastner serves as the first detachable member (131) and the adhesive applied to the velcro fastner serves as the door frame (110).

The door cap (120) may be formed in the same or similar shape as the door frame (110) and cover the first opening (111). The shape and size of the door cap is not limited so long as it can cover the first opening (111) of the door frame (110).

The door cap (120) may be made of soft PVC, hard PVC, PE (polyethylene). PET, and the like. Preferably, it is made of a soft film or a soft PVC film. The door cap (120) may be made of an opaque material, but it is preferable that the door cap (120) is made of a transparent material so that a user can see the outside through it.

When the door cap (120) is a transparent film, the edge of the door cap may be colored using color printing or using a color sheet. In that case, any color may be applied, for example, in consideration of colors of the window frame or a wallpaper.

First and second detachable members (131.132) are provided on the front side of the door frame (110) and the back side of the door cap (120), respectively, so that the door cap (120) is detachably attached to the door frame (110).

The first detachable members (131) may be fixed to the door frame (110), for example, the double-sided tape, the adhesive, etc. The second detachable members (132) may be fixed to the back side of the door cap (120), for example, using the second double-sided tape or adhesive (122).

The first and the second detachable members (131,132) may includes a first magnet fixed along the front edge of the door frame (110) and a second magnet fixed along the edge of the back side of the door cap (120), respectively. The door cap is detachably attached to the door frame (110) by magnetic forces of the first and second magnets having opposite polarities.

In addition, the first and the second detachable members (131,132) may be a metal piece provided on the front side of the door frame (110) and a magnet (110) provided on the back side of the door cap (120), respectively. In another embodiment, the first and the second detachable members (131,132) may be a magnet (110) provided on the front side of the door frame (110) and a metal piece provided on the back side of the door cap (120), respectively.

The first and second detachable members (131.132) may be hook and loop fastners (also referred to as male and female Velcro fasteners) which are installed in a detachably attachable manner on the front side of the door frame (110) and the back side of the door cap (120), respectively.

The magnet may be a conventional magnet such as a rubber magnet or a permanent magnet. It is preferable to use a rubber magnet having flexibility.

As shown in FIG. 4, a tab (140) extending outward from an edge of the door cap may be further provided to easily detach or attach the door cap (120).

In another embodiment, the tab (140) may be extending outward from an edge of the detachable member provided on the back side of the door cap to easily detach or attach the door cap (120). In yet another embodiment, the door cap (120) is a transparent film, a first tab (140) may be formed extending outward from an edge of the transparent film door cap, and a second tab (140) may be formed extending outward from an edge of the detachable member. The first tab and the second tab are attached to each other by a double-sided tape (122). This structure is advantageous to prevents the transparent film door cap (120) from being peeled off from the second detachable member (132) when the tab (140) is pulled to detach the door cap (120) from the door frame (110). This structure helps the detachment of the door cap (120) start from the second detachable member (132), thus resulting in a smooth detachment of the door cap (12) from the door frame (110).

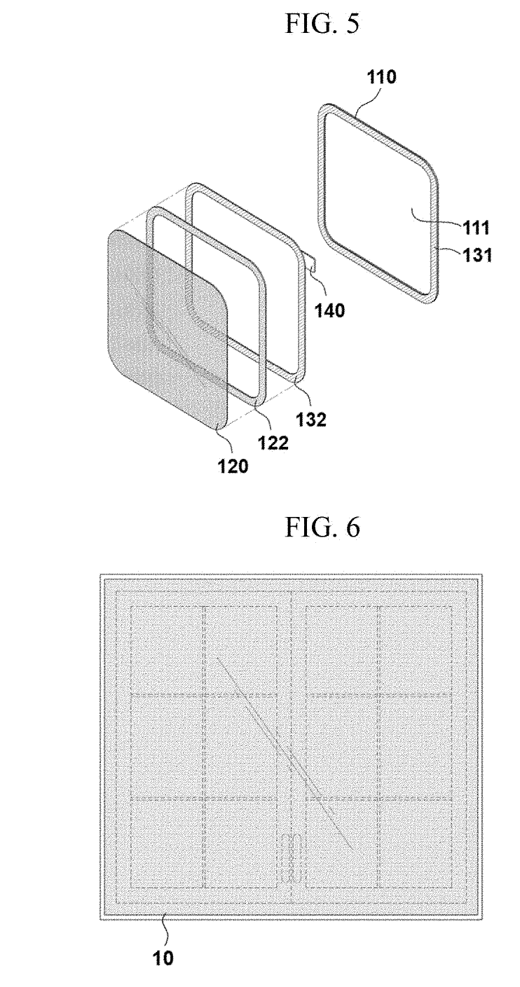

As shown in FIG. 5, the second tab (140) may be attached to the second detachable member (132), which is provided on the back side of the door cap (120), and further extending outside from the edge of the door cap (120).

The second tab (140) may be provided between the second detachable member (132) fixed to the door cap (120) and the first detachable member (131) fixed to the door frame (110). This structure helps the detachment of the door cap (120) start from the second detachable member (132), thus resulting in a smooth detachment of the door cap (12) from the door frame (110).

The attachable window (100) for windproof vinyl according to the present invention is attached to the windproof vinyl (10) installed on the window frame.

As shown in FIG. 6, once the windproof vinyl is installed on the window frame, the window can not be opened or closed for ventilation. It is true for heat shrink windproof vinyl (10) which completely covers the entire window.

The attachable window (100) for windproof vinyl may be installed at a position where the handle of the window is located or at a proper position for a user to open the window.

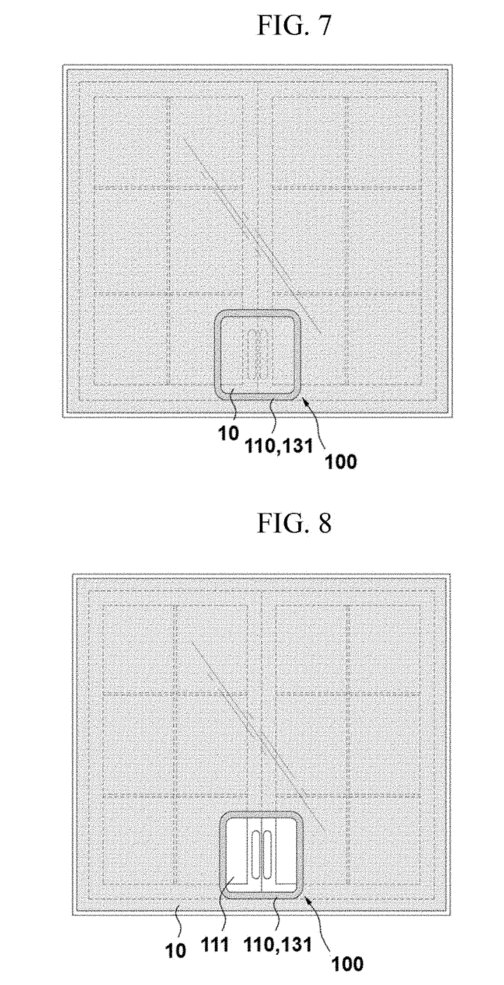

In an embodiment, as shown in FIG. 7, the double-sided tape (110), to which the first detachable member (131) is attached, is peeled off from a release paper. The double-sided tape (110) may be in a window shape and have the first opening (111) in its center. The double-sided tape (110) is attached to the windproof vinyl (10). The to-be-opening area is defined in the windproof vinyl (10) by the first opening (111). In this embodiment, the double-sided tape (110) attached to the windproof vinyl serves as the door frame (111). In another embodiment, a velcro fastner (or a hook and loop fastner) is prepared to serve as the first detachable member (131). Thea velcro fastner may be in a window shape and having the first opening (111) in its center. An adhesive is applied to a back side of thea velcro fastner. The back side of the velcro fastner is attached to the windproof vinyl through the adhesive. The windproof vinyl corresponding to the first opening (111) of the velcro fastner is defined as the to-be-opening area. The to-be-opening area of the windproof vinyl is cut out to form the second opening. In this embodiment, the velcro fastner serves as the first detachable member (131) and the adhesive applied to the velcro fastner serves as the door frame (110).

As shown in FIG. 8, the windproof vinyl (10) corresponding to the first opening (111) is cut out to form the second opening in windproof vinyl (10).

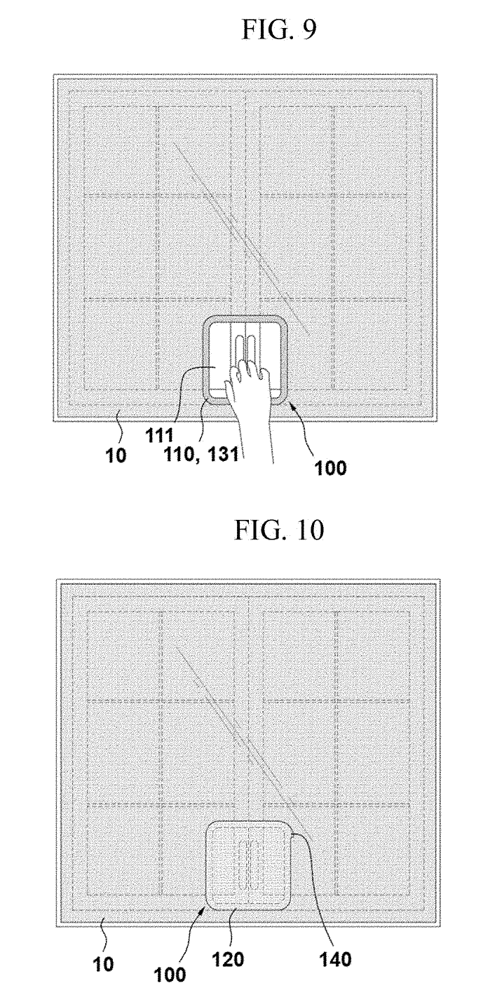

As shown in FIG. 9, a user can open or close the window by inserting his or her hand through the first opening (111) and the second opening, and can freely and conveniently ventilate the room air.

As shown in FIG. 10, after the ventilation completes, the first opening (111) is covered by the door cap (120) to block an external air.

As described above, according to an embodiment of the present invention, the attachable window is attached to the windproof vinyl, which is installed on window frame for thermal insulation, to form the second opening in the windproof vinyl. When ventilation is required, the door cap is detached and a user can open the window through the second opening so that the room air can be easily ventilated. When ventilation is finished, the door cap is attached to cover the first opening to reduce a heat loss.

Some embodiments of the present invention have been described above. However, the present invention is not limited to the specific embodiments described above. It will be apparent to a person having an ordinary skill in the art that various modifications and variations can be made in the present invention without departing from the spirit and scope of the appended claims. Equivalents of the present invention should be considered to be within the scope of the present invention.

### DESCRIPTION OF REFERENCE NUMERALS

10: windproof vinyl
100: window for windproof vinyl
110: door frame (or double-sided tape)
111: first opening
120: door cap
122: double-sided tape
131,132: first and second detachable members
140: tab

What is claimed is:

1. An attachable window for a windproof vinyl, comprising:
a door frame attachable to a windproof vinyl and having a first opening, wherein the windproof vinyl is installable on a window frame;
a door cap covering the first opening; and
first and second detachable members provided on a front side of the door frame and a back side of the door cap, respectively, and detachably attaching the door cap to the door frame.

2. The attachable window of claim 1,
wherein the door frame is a first double-sided tape, or an adhesive.

3. The attachable window of claim 1,
wherein the first and the second detachable members include first and second magnets, respectively,
wherein the first and the second magnets have opposite magnetic polarities to each other and are attachable to and detachable from each other by a magnetic force.

4. The attachable window of claim 1,
wherein the first and the second detachable members include a metal piece and a magnet, respectively, or,
wherein the first and the second detachable members include a magnet and a metal piece, respectively.

5. The attachable window of claim 1,
wherein the first and the second detachable members include hook and loop fastners, respectively,
wherein the hook and loop fastners are attachable to and detachable from each other.

6. The attachable window of claim 1,
wherein the door cap is made of a transparent material.

7. The attachable window of claim 1,
wherein the door cap is a transparent film,
wherein the second detachable member is fixed to a back side of the transparent film using a second double-sided tape or an adhesive.

8. The attachable window of claim 1, further comprising:
a first tab extending outward from an edge of the door cap.

9. The attachable window of claim 8, further comprising:
a second tab extending from an edge of the second detachable member,
wherein the first tab and the second tab are attached to each other, wherein the door cap is a transparent film.

10. The attachable window of claim 1, further comprising:
a second tab extending outward from an edge of the second detachable member.

11. The attachable window of claim 10,
wherein the second tab further extends outside an edge of the door cap.
